(19) United States
(12) Patent Application Publication
(10) Pub. No.: US 2010/0083933 A1
(43) Pub. Date: Apr. 8, 2010

(54) Rotary internal combustion engine with annular chamber

(76) Inventor: Peter Varga, Bratislava (SK)

Correspondence Address: Oppedahl Patent Law Firm LLC, P O Box 5940, Dillon, CO, 80435-5940, US

(21) Appl. No.: 12/530,208

(22) PCT Filed: Sep. 26, 2007
(86) PCT No.: PCT/SK2007/000008

§ 371 Date: Sep. 6, 2009

(30) Foreign Application Priority Data
Apr. 3, 2007 (SK) PP 5029-2007

(51) Int. Cl. F02B 53/00

(52) U.S. Cl. 123/245

(57) ABSTRACT

The rotary nasal annular engine with noses on the annular with internal combustion operates on the principle of a pair of the first rotor (1) and the second rotor (2), as well as with usage of a block (3), where the rotors are placed and rotate synchronously. The block (3), together with the circumference surface (1.9), nose (1.2), (1.3) of the rotor (1) and the rotor (2) determinates the engine's combustion chamber (4.1), (4.2) in the shape of a torus, inside of which the rotor (1) is rotating with at least one nose (1.2). The rotor (2), contains, on its outer circumference surface (2.9), slots (2.7, 2.8), preferably, on its outer circumference surface, for the transition of the nose (1.2). During the nose's (1.2) transition through the slot (2.7), of the rotor (2), the compressed medium (7) is transferred through the storage system (2.5) of the rotor (2) through its intake opening (2.4) of the rotor (2) and through the outgoing opening (2.6) of the rotor (2) into the engine's combustion chamber (4.2)

### TECHNICAL FIELD

The invention is related to the combustion engines with internal combustion and it deals with a substantial change in terms of securing and realization of actions in the processes of the piston combustion engine.

### BACKGROUND ART

Piston petrol engines and diesel engines, as types of combustion engines, are thermal engines, which transform the energy released by explosion and combustion of the fuel into mechanical energy. In this process, the transformation of the chemical energy into mechanical and thermal energy by combustion is a direct moving medium. A change takes place in series of consequent actions, and it consists of preparation and transfer of the fuel, fuel mixture or air, in its compression, in the initiation of the ignition impulses, in the expansion of the combustion products, to which the exploitation of the generated energy's part for the mechanism drive and the emission exhaust is connected. These series of actions are called the operating cycle of the petrol and diesel engines. The operating cycle is ensured by petrol and diesel combustion engines, which operate using different construction principles. Commonly known types of petrol and diesel engines with a static function of the emission exhaust, are engines with rectilinear piston motion. Out of these engines, for example the four-stroke petrol engine operates in four phases, i.e.: in the first phase, the fuel mixture intake takes place, which is the mixture of air and petrol, the second phase is the compression, in the third phase, the compressed fuel mixture explodes due to an electric spark, and in the fourth phase, the exhaust emissions are released. The four-stroke petrol engine with direct injection, also operates in four phases, i.e.: in the first phase, the air intake takes place, in the second phase, the air compression and consequently fuel injection takes place, in the third phase, compressed fuel mixture explodes due to an electric spark, and in the fourth phase, exhaust emissions are released. In case of a diesel engine, in the phase of compression, the air is compressed until it reaches the explosive temperature, and at the end of the compression process, the air is enriched by diesel by injecting it into the cylinder's combustion chamber, which leads to spontaneous ignition of the fuel mixture and to the explosion.

The energy transformation pressure on the piston provides the transmission of the piston's rectilinear motion through the connecting rod and in connection with the crankshaft transforms the circular motion into the rotary motion. Generally, operation of the cylinder engine requires also other moving parts e.g.: camshaft, valves and the distribution to the camshaft.

The gyratory piston engine (Wankel's engine) represents a more progressive concept in providing and realizing the piston combustion engine's actions. Its effectiveness compared to the diesel and petrol engines is increased by using only a minimum of rotary parts and by absence of the parts making a shifting reversible movement. The principle of its operation is as follows: the preparation process strokes, the fuel ignition and the exploitation of the created energy during the fuel explosion take place operating with a gyratory piston, in a shape of a triangular spherical prism. The gyratory triangular piston and the eccentric shaft rotate around their own axles, however, at the same time, the piston moves on the orbit determined by the orbit of the centre of the eccentric shaft, thus the shaft moves in an eccentric manner. The inside of the cylindrical box is shaped as an epitrochoid. The side walls of the piston are constantly pressed to the walls of the box. The sealing of the gyratory piston is secured by metal sealing ledges and the piston is equipped by rounded ledges. Type of the engine, shape of the combustion chamber and upper lubrication is manifested mostly by increased fuel and lubrication oil consumption of the Wankel's engine.

Several solutions deal with the effort to improve the Wankel engine's gyratory piston parameters, which could be included in the present state of relevant technology, however, none of them represents major concept changes.

### DISCLOSURE OF THE INVENTION

The rotary nasal annular engine with noses on the annular with internal combustion solves the above mentioned problems mainly by means of containing only two (favourably three or more) rotary units placed in a block, but also thanks to the method of preparation of the fuel mixture, its transfer, expansion, usage of released energy in the combustion area, transfer of exhaust emission and its exhaust out of the engine. The rotary nasal annular engine with internal combustion is equivalent to the piston four-cylinder four-stroke engine, whose mechanism, for example in case of two cylinders, consists of as many as 35 movable basic parts of the engine (crankshaft, flywheel, 4 con rods, 4 wrist-pins, 4 pistons and 4 sets of piston rings, camshaft, 4 lifters, 8 valve springs+spring gripping elements, 4 intake valves, 4 exhaust valves, not considering the camshaft's driving mechanism (gear wheel, gear belt, pulleys), compared to two or more moving basic parts of the rotary annular nasal engine with noses on the annular with internal combustion.

The rotary nasal annular engine with noses on the annular with internal combustion does not contain a crankshaft, camshaft, valves, pistons, rods, lifters, rockers, valves and distribution to them, moreover, it does not contain eccentrically rotating elements (crankshaft, rotor of the Wankel's engine). The merit of the rotary nasal annular engine with noses on the annular with internal combustion lies in consisting only two moving basic parts—rotors, in comparison to 35 movable basic parts of an adequate four-cylinder piston engine. Rotors of the rotary nasal annular engine with noses on the annular with internal combustion are placed in a block and actions such as preparation of the fuel, initiation of the fuel combustion, transformation and utilization of energy and emission exhaust take place in a sequence of construction and other coherent parametrical and functional combinations of processes typical for operation of a combustion engine.

These processes are initiated and take place by exploitation of at least one pair of the first and second rotor (favourably two or more second rotors) and a block, in which the rotors are placed and rotate synchronously while maintaining partial constructional and functional contact, which is continuous, sealing and non-sealing. Turning axes of the rotors are skew, which are either mutually perpendicular or not perpendicular. The rotors continuously complement each other from the constructional and functional point of view. The block, apart from bordering the space, in which the rotors are placed, continuously determinates sealed or loose parts of the engine's combustion chamber, which is in the appropriate shape of a torus. The first rotor is of a annulary shape with at least one nose on its inner circumference wall, and it moves inside the combustion chamber, which is surrounded by an inner wall of the block and circumference surface of the first rotor as well as the rotating second rotor (favourably more second rotors). The second rotor (favorably more second rotors) can be plate shaped with at least two constructional modifications with slots on its outer circumference. The first rotor contains a rotating output-gear, identical with the axe, for transition of the energy of the powered system. The second rotor (favourably two and more second rotors), also contains as a rotating output for example on the circumference a shaft, and it is synchronously connected with the first rotor and powered by the first rotor. During rotation, both rotors maintain appropriate sealing and non-sealing contact, the contact is maintained also between the rotors and the block. Particular contact parts as well as constructional modifications of both rotors and the block create conditions in the chamber, which are typical for combustion engines.

In the following description of these actions, the principles of the actions of the rotary nasal annular engine with internal combustion are identical to the actions of the rotary nasal engine with internal combustion, registered in the SR Industry Patent Office, under the registration No. PP 5068-2006, from 8 Aug. 2006 and a rotary nasal engine with noses on the annular with internal combustion, registered in the SR Industry Patent Office, under the registration No. PP 5018-2007, from 2 Mar. 2007.

By an appropriate position of the second rotor (favourably more second rotors) and the block as well as through the openings in them, and by rotation of the first rotor, the medium intake into the combustion chamber is secured (air, oxygen, or fuel mixture). The intake medium is transferred by rotation of the first rotor in front of the nose, and it is compressed at the contact area of the second rotor (favourably two and more second rotors), and it is transferred through the transfer system in the second rotor (favourable two or more second rotors) into the combustion chamber behind the nose of the first rotor. The injection of the fuel into the compressed air or oxygen takes place in the combustion chamber (fuel mixture can be conveniently compressed by the rotation of the second rotor—favourably two and more second rotors), which initiates the ignition of the fuel mixture. Explosion initiates expansion and rotation of the first rotor. Consequently, through the rotation of the first rotor and through the determination of the second rotor (favourably two and more second rotors) and the block and through the slots as well as through further determination of the second rotor (favourably two and more second rotors) and by the rotation of the first rotor, the emission exhaust is realized. Consequently, the nose of the first rotor moves through the contact area using the slot on the second rotor and the intake phase begins repeatedly.

In the case of the rotary annular nasal engine with noses on the annular with internal combustion, which is the subject of the protection, significant differences and mostly advantages are obvious compared to the piston engine, i.e.: significant simplification and reduction in size of the construction of combustion engines, decrease of production expenses, high reliability and no-failure operation, which consequently leads to decrease of repair and maintenance costs, moreover, improvement of fuel efficiency, increase of actual performance of the engine, significantly lower mechanical losses, higher total efficiency compared to pistons engines, mainly due to better mechanical efficiency, there is no oscillation during rotation of a rotary engine as there is during shifting movement in the case of a piston engine, thus vibrations are not transferred into the frame of e.g. a vehicle, this consequently reflects in a lower noise, lower stress of the springs, maximum combustion pressure in the combustion chamber of the rotary engine is supposedly lower by more than 30% compared to an equivalent piston engine, lower short-term mechanical levy of the rotor nose and the chamber, the maximum temperature in the chamber during combustion is supposedly lower, moreover, the CO and the unburned hydrocarbon (HC) production is lower compared to a piston engine, there is no torso oscillation, only the output shaft is stressed during torsion, perfect balance of the engine, the motor is capable of operating at a considerably higher RPM (higher RPM=better performance), when applied in e.g. sport cars, supposedly, the engine—due to perfect balance—can run at cca. 20 000 RPM, the rotary engine can be constructed as either petrol or diesel engine, it is also appropriate to use other conventional as well as alternative fuels, the engine can operate with natural intake or it can be turbo-supercharged, the rotors also function as flywheels. During the engine's expansion, the torque takes place directly on the shaft, in contrary to the piston engine with a crank mechanism, where the resulting force/energy onto the piston is transferred from the piston through the bearings of the piston shank, shaft and the shaft bearing to the crankshaft, and during this transfer, mechanical losses occur together with loading of several components. The rotary nasal annular engine with noses on the annular with internal combustion operates with a significantly effective usage of the space, moreover, it is approximately one third of the height, also one third of the length of an equivalent four-cylinder piston engine with the same actual power, thus, supposing the rotary nasal engine with internal combustion had the same proportions as the piston engine, its actual power would be several times higher. Another advantage of the rotary nasal annular engine with internal combustion is the assumption that it will reach approximately up to 70% of the value of the power weight of the piston engine; maximum piston speed compared to the piston engine will be lower by approximately 8%. Mounting of a rotary nasal annular engine could by realised in 35% shorter time as mounting of an equivalent four-cylinder piston engine.

Advantages of the rotary nasal annular engine with noses on the annular with internal combustion compared to the Wankel engine are: there are complications with corners sealing in the case of Wankel engines, however, these do not occur in the case of the rotary nasal annular engine with internal combustion. The surface-cubature ratio of the combustion chamber is considerably smaller than in the case of the Wankel engines which have a long, slotted combustion space, moreover, CO emissions and not-burned hydrocarbon (HC) that emerge at the combustion space walls of the rotary nasal annular engine will be lower than in the case of the Wankel engines, and comparable to the values of pistons engines. It is possible to apply upper lubrication; however, lower lubricant consumption is assumed compared to Wankel engines.

The rotary nasal annular engine with noses on the annular with internal combustion is even more effective in terms of space filling, compared to the rotary nasal engine with internal combustion, the rotary nasal annular engine with internal combustion comprises twice as high engine power as the rotary nasal engine, and in terms of the processes taking place inside, the engine is equivalent to a four-cylinder four-stroke piston engine.

Working pair (favourably three and more) of the rotors of the rotary nasal annular engine with noses on the annular with internal combustion, together with the block, as one complex possibly on the same axle—placing the shafts simultaneously with other favourably similar units, which is an advantage compared to the rotary nasal engine with internal combustion, where the axles of both rotors are non-intersecting.

The rotary nasal annular engine with noses on the annular with internal combustion compared to the rotary nasal annular engine with internal combustion has the advantage of lower oscillation of the second rotor during the transfer of the noses through the second rotor.

### DESCRIPTION OF THE PICTURES

The principle of the rotary annular nasal engine with noses on the annular with internal combustion and the process of the combustion mixture preparation, its ignition and the exploitation of the released energy for the exploitation of the described process, is schematically illustrated in the pictures. Considering that the solution, which is protected, creates premises for a number of constructional application variations and its merit can be described through projecting different states, individual pictures ought to be perceived only as illustrative, in order to illustrate the invention's merit.

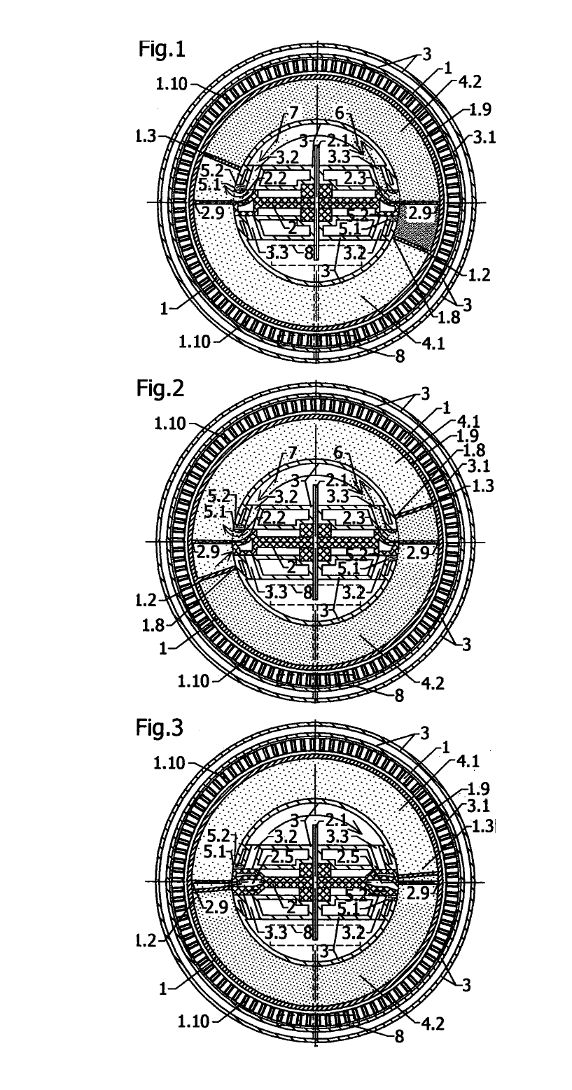

The FIG. 1-13 illustrate the longitudinal section of the rotor 1 and the cross-section of the rotor 2, displaying the operating process of the rotary nasal engine with noses on the annular with internal combustion with two noses on the rotor 1, and the principle of the combustion mixture preparation, its ignition and the exploitation of the released energy.

FIG. 14 illustrates the state in the cross-section of the rotor 1 and the longitudinal section of the rotor 2 identical with the FIG. 1 of the operation process of the rotary nasal annular engine with internal combustion with two noses on the rotor 1.

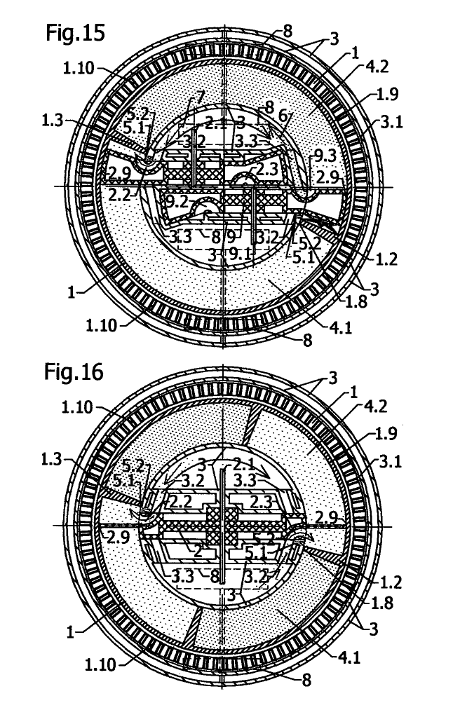

FIG. 15 illustrates the longitudinal section of the rotor 1 and the cross-section of the rotors 2 and 9, the picture projects the state according to the FIG. 1, the operating process of the rotary nasal annular engine with internal combustion with two noses on the rotor 1.

FIG. 16 illustrates the longitudinal section of the rotor 1 and the cross-section of the rotor 2 displaying the state according to the FIG. 1—operating process of the rotary nasal annular engine with internal combustion with four noses on the rotor 1.

### INDIVIDUAL FIG. 1-13

FIGS. 1 and 2 illustrate the intake of the medium behind the nose 1.3 of the rotor 1 into the operating chamber 4.1 through the first segment 3.2 of the intake passage in the block 3, the second segment 2.2 in the second rotor 2, and the medium compression in front of the nose 1.2 of the first rotor 1 inside the combustion chamber 4.1, concurrently it displays the exhaust emission transfer in front of the nose 1.3 of the first rotor 1 inside the combustion chamber 4.2, through the first segment 2.3 of the exhaust canal inside the rotor 2 and the second segment 3.2 in the block 3 and the expansion behind the nose 1.2 inside the combustion chamber 4.2.

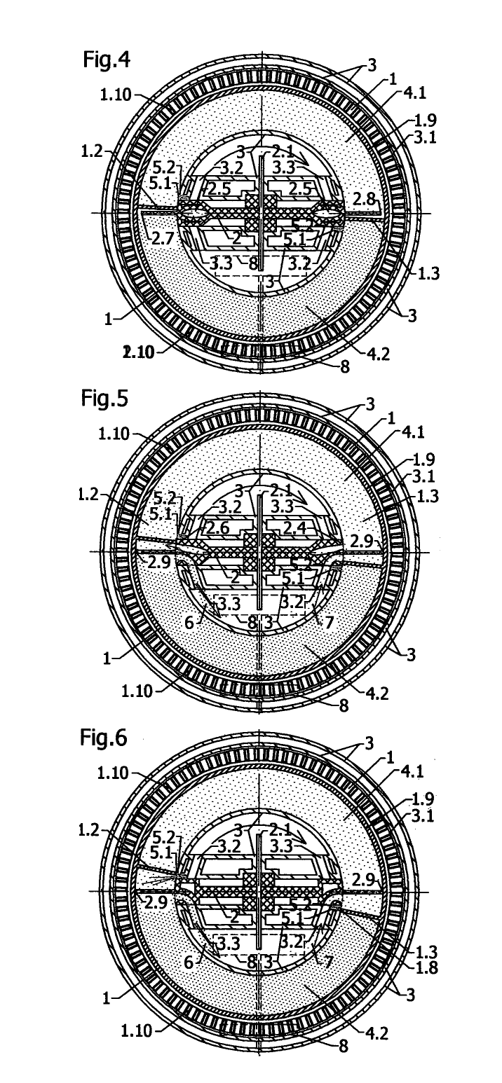

FIG. 3 illustrates the end of the medium intake and filling of the chamber 4.1 by this medium, transfer of this medium behind the nose 1.2 of the first rotor 1 into the storage system 2.5 in the rotor 2 through the opening 2.4, moreover, the end of the exhaust emission, as well as the expansion inside of the combustion chamber 4.2. FIGS. 4 and 5 illustrate the transition of the nose 1.2 of the first rotor 1 with an appropriately shaped slot 2.7 on the second rotor 2 and the transition of the nose 1.3 of the first rotor 1 through an appropriately shaped slot 2.8 on the second rotor 2, as well as the transition of the compressed medium from the fuel storage container 2.5 in the rotor 2 through the opening 2.6 into the determined area of the combustion chamber 4.2. behind the nose 1.2 of the rotor 1 and the rotor 2 and the emissions exhaust (6) from the chamber 4.2 in front of the nose 1.3 through the first segment 2.3 of the exhaust channel in the second rotor 2 and the second segment 3.2 in the block 3, consequently, the medium compression process inside the combustion chamber 4.1 in front of the nose 1.2 of the first rotor 1 and the medium intake behind the nose 1.3 of the rotor 1 into the combustion chamber 4.1, through the first segment 3.2 of the intake channel in the block 3, second segment 2.2 in the second rotor 2.

FIG. 6 illustrates the medium intake behind the nose 1.2 inside the combustion chamber 4.2 (supposing the medium has not already been enriched by fuel during the intake through the intake openings 3.2 of the block 3), and the emissions exhaust (6) from the chamber 4.2 in front of the nose 1.3, moreover, the medium compression inside the combustion chamber 4.1 in front of the nose 1.2 of the first rotor 1 and the medium intake behind the nose 1.3 of the rotor 1 into the combustion chamber 4.1.

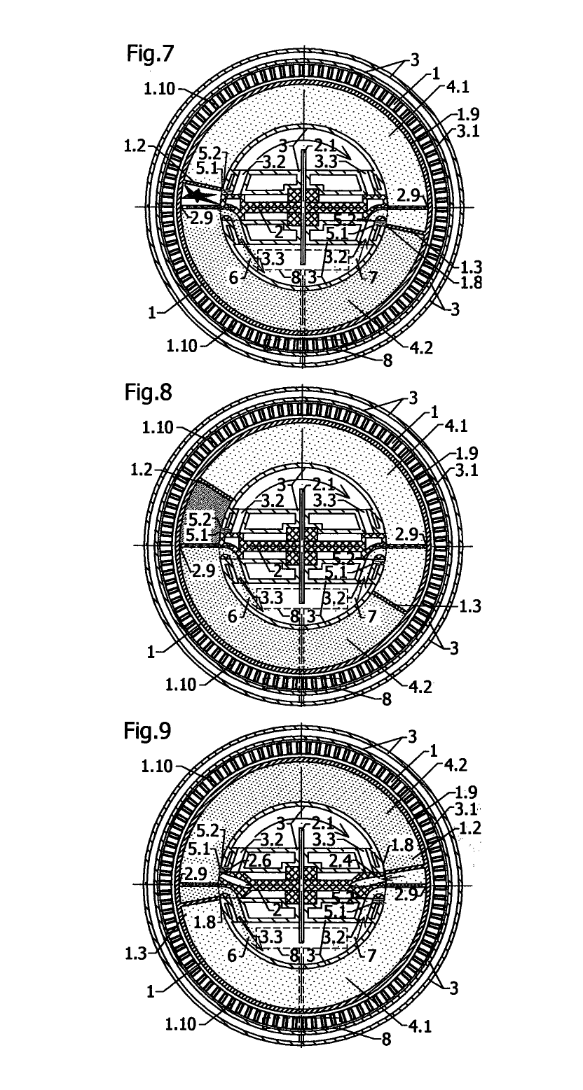

FIG. 7 illustrates the ignition of the medium behind the nose 1.2 of the rotor 1 inside the combustion chamber 4.2 and the emissions exhaust (6) from the chamber 4.2 in front of the nose 1.3, moreover, the compression of the medium inside of the combustion chamber 4.1 in front of the nose 1.2 of the first rotor 1 and the medium intake behind the nose 1.3 of the rotor 1 into the combustion chamber 4.1.

FIG. 8 illustrates the gas expansion-transformation of chemical energy into mechanical energy inside the chamber 4.2 and the emissions exhaust (6) from the chamber 4.2 in front of the nose 1.3, moreover, the compression of the medium inside the combustion chamber 4.1 in front of the nose 1.2 of the first rotor 1 and the intake of the medium behind the nose 1.3 of the rotor 1 into the combustion chamber 4.1

FIG. 9 illustrates the gas expansion inside of the chamber 4.2 and the end of the emissions exhaust from the chamber 4.2 in front of the nose 1.3, moreover, the medium transfer from the combustion chamber 4.1 through the nose 1.2 of the rotor 1 into the storage system 2.5 inside of the rotor 2 through the opening 2.4 and the end of the medium intake behind the nose 1.3 of the rotor 1 into the combustion chamber 4.1

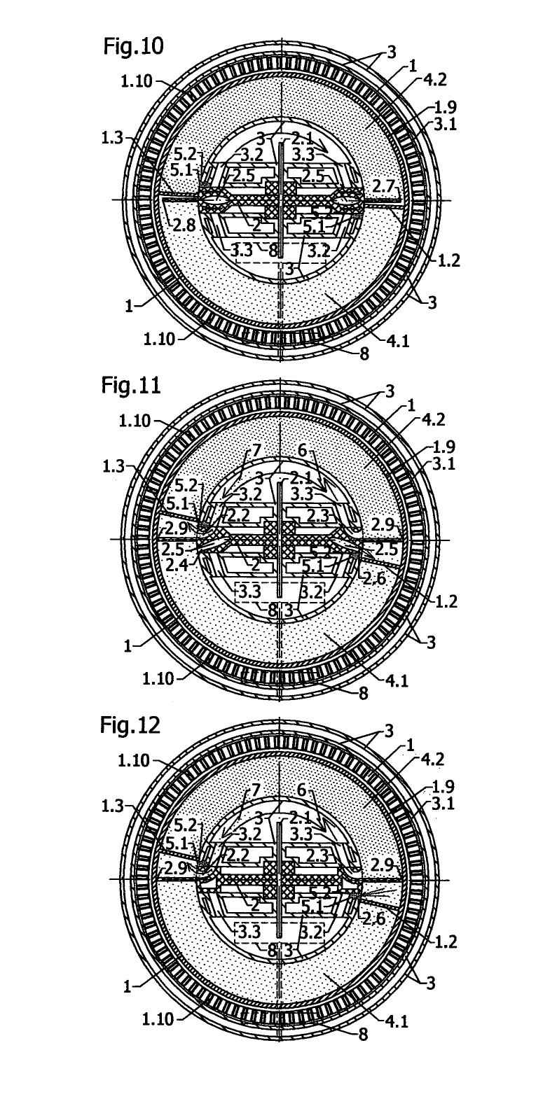

FIGS. 10 and 11 illustrate transition of the nose 1.2 of the first rotor 1 through an appropriately shaped slot 2.7 on the second rotor 2 and the transition of the nose 1.3 of the first rotor 1 through an appropriately shaped slot 2.8 on the second rotor 2 as well as the beginning of the medium intake behind the nose 1.3 of the rotor 1 into the combustion chamber 4.1, and the medium compression inside the chamber 4.1 in front of the nose 1.2 of the first rotor 1, moreover, the transfer of the compressed medium from the container 2.5 inside of the rotor 2 through the opening 2.6 into the determined area of the combustion chamber 4.2 behind the nose 1.2 of the rotor 1 and the emission exhaust (6) from the chamber 4.2 in front of the nose 1.3.

FIG. 12 illustrates the medium intake behind the nose 1.3 of the rotor 1 into the combustion chamber 4.1 and the compression of the medium inside the combustion chamber 4.1 in front of the nose 1.2 of the first rotor 1, moreover, the emissions exhaust from (6) the chamber 4.2 in front of the nose 1.3 and the medium intake behind the nose 1.2 inside the combustion chamber 4.2 (supposing the medium has not already been enriched by fuel during the intake through the intake openings 32 of the block 3).

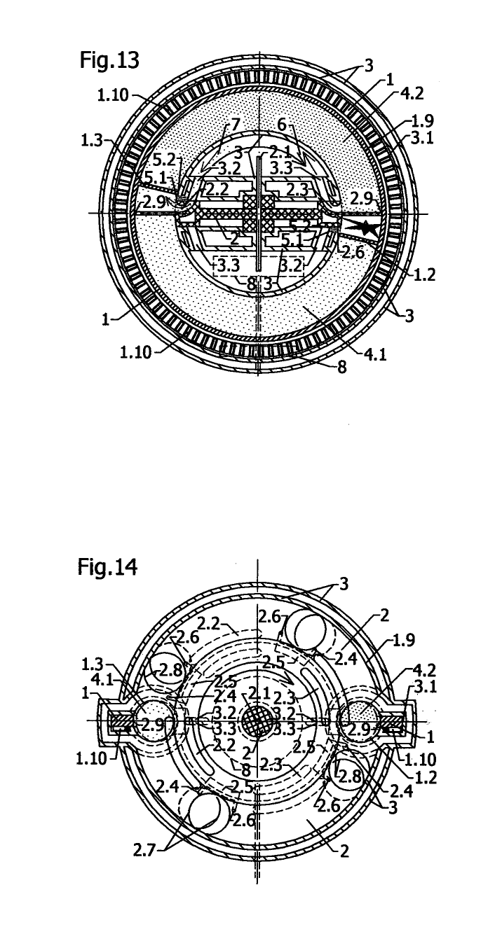

FIG. 13 illustrates the intake of the medium behind the nose 1.3 of the rotor 1 into the combustion chamber 4.1 and the medium compression inside the combustion chamber 4.1 in front of the nose 1.2 of the first rotor 1, moreover, the emissions exhaust (6) form the chamber 4.2 in front of the nose 1.3 and the ignition of the medium behind the nose 1.2 of the rotor 1 inside the combustion chamber 4.2.

### Examples of the Invention Realization

The rotary nasal annular engine with noses on the annular with internal combustion is unique and exceptional thanks to its original construction—it has only two (favourably more) rotary parts—rotor 1 and 2 (favourably other second rotors 9) placed in the block 3 and thanks to the processes typical for the operation of a combustion engine.

The rotary nasal annular engine with noses on the annular with internal combustion operates with the same principles as the rotary nasal engine with internal combustion, registered in the SR Industry Patent Office, under the registration No. PP 5068-2006, from 8 of Aug. 2006 and a rotary nasal engine with noses on the annular with internal combustion, registered in the SR Industry Patent Office, under the registration No. PP 5018-2007, from 2 Mar. 2007.

The rotary nasal annular engine with noses on the annular with internal combustion operates using at least one pair of the first rotor 1 and the second rotor 2 (favourably other second rotor(s) 9) together with the block 3, which actually contains rotating rotor 1 and rotor 2 (favourably other rotor(s) 9). Rotor 1 and rotor 2 (favourably other rotor(s) 9) synchronously rotate and continuously maintain partial constructional and functional contact, which is between the rotors 1 and 2 (favourably other rotor(s) 9) and the block 3 sealing and non-sealing. The axes of the rotor 1 and rotor 2 (favourably other rotor(s) 9) are either mutually parallel or appropriately diverted from the parallel direction. The second rotor 2 (favourably other rotor(s) 9), favourably cylinder-plate shaped, passes through the combustion chamber 4.1, (4.2) dividing it at least two places, compared to the rotary nasal engine with internal combustion, where the second rotor 2 passes through the combustion chamber 4.1, (4.2) dividing it at one place. The second rotor 2 (favourably other rotor(s) 9) contains a gear 2.10, as a rotary output, for example on its circumference, and it is synchronously connected through it by the gear mechanism 8, with the first rotor 1—which is the driving rotor 1.

The first rotor 1 and the second rotor 2 (favourably other rotor(s) 9) continuously complement each other from the constructional and functional point of view. Block 3, apart from functioning as cover of the space, in which the first rotor 1 and the second rotor 2 (favourably other rotor(s) 9) are placed, it continuously determinates together with the rotor 1 and the second rotor 2 (favourably other rotor(s) 9) sealed or loose parts of the engine's combustion chamber 4.1, (4.2) together with the rotors. The engine's combustion chamber 4.1, (4.2) is appropriately shaped in the shape of a torus and is bordered with an inner wall 3.1 of the block 3 and with the circumferential surface 1.9 of the first rotor 1, as well as the rotating second rotor 2 (favourably other rotor(s) 9). It is advantageous, if the first rotor 1 is in a favourably of the annular shape with at least one nose 1.2, 1.3, on its inner circumference 1.9, which rotates in the engine's combustion chamber 4.1, (4.2). The second rotor 2 (favourably other rotor(s) 9) is favourably of a cylinder-plate shape, with slots 2.7, 2.8 (favourably with slots 9.7, 9.8 of other rotor(s) 9) on its circumference 2.9 of the second rotor 2 (favourably on the circumference 9.9 of the other rotor(s) 9). The first rotor 1 contains on its outer circumference a gear 1.10 in order to transmit the power into the driven system. The second rotor 2 has on the rotating axle a rotating output-shaft 2.1 (favourably shaft 9.1 on the other rotor(s) 9), and it is synchronously connected through it by the gear mechanism 8, with the rotary output-gear 1.10 of the first rotor 1. The contact part of the first rotor 1 and the second rotor 2 (favourably other rotor(s) 9) has at least two slots 2.7, 2.8 (favourably with slots 9.7, 9.8) on its outer circumference 2.9 (favourably on its outer circumference 9.9 on the rotor 9), and at least one nose 1.2, (1.3), whose circumference 1.8 duplicates the volume of the combustion chamber 4.1, (4.2), and this nose 1.2, (1.3), is placed on the circumference 1.9 of the first rotor 1. Slots 2.7, 2.8 (favourably slots 9.7, 9.8) are on ther outer circumference 2.9 (favourably on its circumference 9.9 on the other rotor(s) 9) are equipped with specific constructional modifications, which enable sealing and non-sealing transfer of the nose 1.2, 1.3, through the slots 2.7, 2.8, of the second rotor (favourably through slots 9.7, 9.8 of the rotor 9). Mutually appropriate position of the second rotor 2 with the opening 2.2 in it (favourably through opening 9.2 on the other rotor(s) 9), towards the block 3 with the opening 3.2 in it, along with determination of the second rotor 2 (favourably other rotor(s) 9), and with the rotation of the first rotor 1, secures the absorption of the medium 7 (air, oxygen or fuel mixture) into the engine's combustion chamber 4.1, behind the nose 1.3. Intake medium, due to rotation of the first rotor 1 and due to determination by the second rotor 2 (favourably other rotor 9), is compressed inside the engine's combustion chamber 4.1 in front of the nose 1.2. Compressed medium is moved from the front of the nose 1.2 of the first rotor 1 of the engine's combustion chamber 4.1 through the transition system 2.4, 2.5, 2.6 (favourably other transition system 9.4,9.5,9.6 of the rotor(s) 9), it's intake opening 2.4 (favourably other intake opening 9.4 of the rotor(s) 9) and outgoing opening 2.6 (favourably other outgoing opening 9.6 of the rotor(s) 9), which are situated in the second rotor 2 (favourably other rotor(s) 9), into the engine's combustion chamber 4.2, behind the nose 1.2 of the first rotor 1, after the transfer of the nose 1.2 of the first rotor 1 across the contact area of the first slot 2.7 of the second rotor 2 (favourably the opening 9.7 on the other rotor(s) 9). Here, the medium 7 (air or oxygen, possibly fuel mixture) can be pressed by the rotation of the second rotor 2 (favourably other rotor(s) 9) and by its appropriate shape (during the transfer of the air or oxygen, consequent injection of the fuel takes place 5.1), and the explosion of the fuel mixture 7 in the engine's combustion chamber 42 is initiated, either by compressing the mixture which would lead to spontaneous ignition or by a spark 5.2. Rotation of the first rotor 1 is initiated by explosion and expansion, and by generated pressure on the nose 1.2 of the rotor 1. Consequently, by rotation of the first rotor 1 and by mutually appropriate position of the second rotor 2 (favourably other rotor(s) 9), with the opening 2.3 in it, (favourably through the opening 9.3 of the other rotor 9), towards the block 3 with the opening 3.3 in it, along with determination of the second rotor 2, the emissions exhaust 6 from the engine's combustion chamber 4.2 takes place. Consequently, the nose 1.3 of the first rotor 1 is transferred through the contact area of the second slot 2.8 (favourably other slot 9.8) of the second rotor 2 (favourably other rotor(s) 9) and the intake of the medium takes place repeatedly.

### INDUSTRIAL EFFICIENCY

The rotary nasal annular engine with noses on the annular with internal combustion can be applied in all applications which nowadays use classical piston combustion engines, including static and dynamic engines, small, middle sized car engines, aircraft and big engines, as well as high-speed or low-speed engines. The rotary nasal annular engine with noses on the annular with internal combustion can be constructed in the same manner as a petrol engine; it is also possible for the engine to operate using other conventional and alternative fuels, it can operate with natural absorption or turbo-supercharging. During transformation of the chemical energy into mechanical energy, the rotary nasal engine with noses on the annular with internal combustion operates in a rotary motion not in a rectilinear motion, thus there is no swinging motion, and therefore there is no reversible phase and eccentric rotation. The number of movable parts is extremely low—2 or 3, which assumes a low break-down rate and therefore high reliability. The operating pair (favourably three or more) of rotors together with the block can be synchronously combined in various combinations, as it is described in the Description of the invention and the patent rights-protection entitlement.

1-4. (canceled)

5. The rotary nasal annular engine with noses on the annular with internal combustion is characterized by the fact that it consists of a block (3), in which the constructional and functionally synchronous combination of at least one first rotor (1) and at least one second rotor, (2) favourably with other rotor(s) (9), is arranged; these rotors are in mutual, partial contact, which is continuous, and sealing and non-sealing, whereas
the rotation axle of the first rotor (1) and the rotation axle of the second rotor (2), favourably other rotor(s) (9) are skew or parallel,
the first rotor (1) contains a rotary output—the gear (1.1) for interconnection through transfer mechanism transfer mechanism (8) towards driving power system of the second rotor (2)—shaft (2.1)—favourable towards the rotation axle, favourable shaft (9.1) of the other rotor(s) (9),
inner circumference (1.9) of the first rotor (1) is equipped with at least one nose (1.2), with the contact surface (1.8) adjusted for sealing as well as non-sealing contact with the inner wall (3.1) of the block (3), with the circumference (2.9) and slots (2.7, 2.8) of the second rotor (2), favourably with the circumference (9.9) and slots (9.7), (9.8) of the other rotor(s) (9),
inner circumference (1.9) of the first rotor (1), contact surface (1.8) of at least one nose (1.2) of the first rotor (1), inner wall (3.1) of the block (3) define the chamber (4.1, 4.2), inner circumference of the second rotor (2), favourably other rotor(s) (9), appropriately in the shape of a torus,
contact part of the circumference (2.9) of the second rotor (2), favourably other circumference (9.9) of the rotor(s) (9), is equipped with at least one contact section, which interferes with the chamber area (4.1, 4.2), or at least defines it, and it is equipped with the slots (2.7, 2.8) favourably slots (9.7), (9.8) of the other second rotor(s) (9) and this circumference (2.9) of the second rotor (2), favourably circumference (9.9) of the other second rotor(s) (9), as well as the constructional slots (2.7), (2.8) of the second rotor (2), favourably slots (9.7), (9.8) of the other rotor(s) (9), in coordination with the first rotor (1) and with the block (3) create suitable conditions in the chamber area (4.1, 4.2) for carrying out processes typical for combustion engines;
the first rotor (1), contact part of the circumference (2.9) of the second rotor (2), favourably contact parts of the circumference (9.9) of the other rotor(s) (9) and inner wall (3.1) of the block (3), continuously define chamber parts (4.1, 4.2),
is equipped with a system for the injection of fuel (5.1), if appropriate, for preparation of the fuel mixture (7) and its transfer into the chamber area (4.2) of the combustion chamber,
block (3) is equipped with at least one part of the absorption canal-opening (3.2) in the block (3), which is connected to the relevant source system with the medium absorption (7) (fuel mixture, air or oxygen) and the second rotor (2), favourably other rotor(s) (9), is equipped with the second section of the absorption canal opening (2.2) in the second rotor (2), favourably other absorption canal with opening (9.2) in rotor(s) (9), which is connected to the chamber area (4.1), while the first section (3.2) and the chamber area (4.1) are mutually interconnected by the second section of the absorption canal (2.2) of the second rotor (2), favourably with other second section of the absorption canal (9.2) of the other rotor(s) (9), and by rotation of the second rotor (2) favourably other rotor(s) (9), only during the absorption of the medium (7) (fuel mixture, air or oxygen),
in at least one of the contact slots (2.7) of the second rotor (2), there is transition system (2.4), (2.5), (2.6) created, favourably other transition systems (9.4), (9.5), (9.6) in another contact slot (9.7) of the rotor (9), consisting of a storage container (2.5) of the second rotor (2), favourably other opening (9.4) of the rotor (9) from the chamber area (4.1) and the output (2.6) of the second rotor (2), favourably other output (9.6) of the rotor (9) into the chamber area (4.2) for the medium (7)—fuel mixture, air or oxygen,
block (3) is equipped with at least one second section with the opening (3.3) of the outgoing canal, which is consistent with the adequate emission exhaust (6) and the other rotor (2) is equipped with the first section (2.3) of the outgoing canal, favourably other first section (9.3) of the other rotor (9), which is interconnected to the chamber area (4.2), while the first section with the opening (3.3) and the chamber area (4.2) are mutually interconnected with the second section with the opening of the outgoing canal (2.3) of the second rotor (2), favourably with other opening of the outgoing canal (9.3) of the other rotor (9), by rotation of the second rotor (2), favourably rotor(s) (9), only during transmission of the exhaust emission (6),
the first rotor (1) and the second rotor (2), favourably other rotor(s) (9), are adjusted for a synchronous rotation in the same direction.

6. The rotary nasal annular engine with noses on the annular with internal combustion according to claim 5, which is characterized by the fact that one basic working system of the engine contains two rotors (1 and 2), favourably other rotor(s) (9), where
other operating units can be placed on the same axle-shaft simultaneously in a favourable manner,
all these working units (1), (2) favourably other rotor(s) (9), are synchronously interconnected.

7. The method of preparation of the medium for the rotary nasal annular engine with noses on the annular with internal combustion, where the absorption and compression take place, together with the ignition and exploitation of the released energy
expansion and exhaust of the emission in the rotary nasal engine with internal combustion according to claim 5, is characterized by the fact that with the exploitation of the continuous sequence of the constructional and coherent parametrical and functional combinations in certain intervals, continuous initiation and a continuing sequence of the processes, or at least two or more sequences of the processes concurrently, these processes are typical mainly for the operation of combustion engines and are initiated and taking place in the sealing or non-sealing chamber areas (4.1, 4.2, . . . ), while these are continuously determined in the chamber areas in which the following processes take place:
intake of the medium (7)—fuel mixture, air or oxygen, through the first section of the intake canal through the opening (2.2) in the second rotor (2), favourably other section of the intake canal through opening (9.2) of the rotor (9), into the area of the chamber (4.1),
compression of the intake medium (7)—fuel mixture, air or oxygen,
transfer of the intake medium (7)—fuel mixture, air or oxygen from the chamber area (4.1), through the transition system, its intake opening (2.4) of the rotor (2), favourably other intake opening (9.4) of the rotor (9), reservoir (2.5) of the rotor (2), favourably other reservoir (9.5) of the rotor (9) and outgoing opening (2.6) of the rotor (2), favourably other outgoing opening (9.6) of the rotor (9), into the chamber area (4.2)
expansion—initiating explosion and afterwards the expansion,
exhaust—transfer of the exhaust emission (6) from the chamber area (4.2), trough the outgoing section, its first section (2.3) of the rotor (2), favourably other outgoing opening (9.3) of the rotor(s) (9), through the next section (3.3) of the block (3),

8. The method of preparation of the medium for the rotary nasal annular engine with noses on the annular with internal combustion, where the intake and the compression take place, its ignition and the use of the released energy-expansion and the emission exhaust inside of the rotary nasal engine with noses on the annular with internal combustion, according to claim 5 is the same as the protection claim 5 of the rotary nasal engine with internal combustion, characterized by the fact that the second rotor (2), favourably other rotor(s) (9), favourably plate shaped, proceeds through the combustion chamber (4.1), (4.2) dividing it at least at two places;
the second rotor (2), favourably other rotor(s) (9), contains a on the rotating axle a rotating output-shaft (2.1) of the second rotor (2), favourably other gear (9.1) of other rotor(s) (9), and it is synchronously interconnected by a transfer mechanism (8), to the gear (1.10) of the first rotor (1), which is the driving power.
